(19) United States
(12) Patent Application Publication
(10) Pub. No.: US 2005/0190044 A1
(43) Pub. Date: Sep. 1, 2005

(54) Wireless mobile security component system and method

(76) Inventor: Mark Rutledge, Murrieta, CA (US)

Correspondence Address: MERLE W. RICHMAN, III, P.O. BOX 3333, LA JOLLA, CA, 92038, US

(21) Appl. No.: 10/789,534

(22) Filed: Feb. 26, 2004

(51) Int. Cl. B60R 25/10

(52) U.S. Cl. 340/426.1; 340/426.11; 340/426.13; 340/426.18

(57) ABSTRACT

A mobile alarm method, system component, and alarm system, where the component or alarm system is fixably located within a passenger vehicle and the component communicates wirelessly with a mobile alarm controller and the component performs an alarm indication function based on signals received from the mobile alarm controller.

### BACKGROUND

1. Field of the Invention

The invention relates generally to mobile security systems, and more particularly, to components employed in mobile security systems.

2. Description of Related Art

Mobile alarm systems commonly employ a central alarm controller and one or more components. The components are physically separate from the central alarm controller (otherwise they may be incorporated into the central alarm controller). For example, in automobile alarm systems, a central alarm system may be located in a passenger compartment while an alarm indicator (component), such as a siren, may be located in an engine compartment. Commonly, the central alarm controller communicates with components, such as the alarm indicator, via one or more conductive wires. In some mobile environments, it is difficult, tedious, or nearly impossible, to run wires between the central alarm controller and some alarm components.

A need thus exists for a mobile alarm system and method that eliminates or reduces the wiring between the central alarm controller and one or more alarm components. The present invention provides such a mobile alarm system and method.

### SUMMARY OF THE INVENTION

The present invention is a mobile alarm method and a system component, where the component is fixably located within a passenger vehicle. In this embodiment, the system component includes means for wirelessly receiving signals from a mobile alarm controller. The component further includes means for performing an alarm indication function based on signals received from the mobile alarm controller.

In the mobile alarm system component the means for performing an alarm indication function may include a means for performing an alarm indication function when a signal has not been received from the mobile alarm controller for a predetermined time interval. Further, the means for performing an alarm indication function may include means for generating an audible alarm indication based on signals received from the mobile alarm controller.

In an exemplary embodiment the mobile alarm controller is fixably located within the passenger vehicle. In this embodiment the passenger vehicle may have a first and a second compartment where the compartments are physically separated. Further, the means for wirelessly receiving signals from a mobile alarm controller may be fixably located within the first compartment of the passenger vehicle and the mobile alarm controller may be fixably located in the second compartment. In an exemplary embodiment, the first compartment may be an engine compartment and the second compartment may be a passenger compartment.

The present invention also includes a mobile alarm system fixably located within a passenger vehicle. The mobile alarm system may include a mobile alarm controller and a mobile alarm component. The mobile alarm controller may be operable to enable wireless data communications. The mobile alarm component may be operable to enable wireless data communications with the mobile alarm controller. In addition, the mobile alarm component may include a processor that is operable to perform an alarm indication function based upon signals received from the mobile alarm controller.

In an exemplary embodiment the component processor may be operable to perform an alarm indication function when a signal has not been received from the mobile alarm controller for a predetermined time interval. Further, the component processor may be operable to cause the generation of an audible alarm indication based on signals received from the mobile alarm controller.

The present invention may also include a method of installing a mobile alarm system within a passenger vehicle. The method includes fixably installing, in the passenger vehicle, a mobile alarm controller that is operable to enable wireless data communications in the passenger vehicle. The method may include fixably installing, in the passenger vehicle, a mobile alarm component that is operable to enable wireless data communications with the mobile alarm controller where the component includes a processor that is operable to perform an alarm indication function based upon signals received from the mobile alarm controller.

### BRIEF DESCRIPTION OF THE DRAWINGS

The features, objects, and advantages of the present invention will become more apparent from the detailed description set forth below when taken in conjunction with the drawings in which like reference characters identify correspondingly throughout and wherein:

FIG. 1A is a simplified block diagram of an exemplary mobile alarm system in accordance with the present invention.

FIG. 1B is a block diagram of another exemplary mobile alarm system in accordance with the present invention.

FIG. 1C is a block diagram of a further exemplary mobile alarm system in accordance with the present invention.

FIG. 2 is a block diagram of an exemplary central alarm controller that may be included in an exemplary alarm system of the present invention.

FIG. 3 is a block diagram of an exemplary alarm indicator (component) that may be included in an exemplary alarm system of the present invention.

FIG. 4 depicts an exemplary process that may be executed or performed by an exemplary alarm indicator in accordance with the teachings of the present invention.

FIG. 5 depicts an exemplary process that may be executed or performed by an exemplary central alarm controller in accordance with the teachings of the present invention.

### DETAILED DESCRIPTION

Throughout this description, embodiments and variations are described for the purpose of illustrating uses and implementations of the invention. The illustrative description should be understood as presenting examples of the invention, rather than as limiting the scope of the invention.

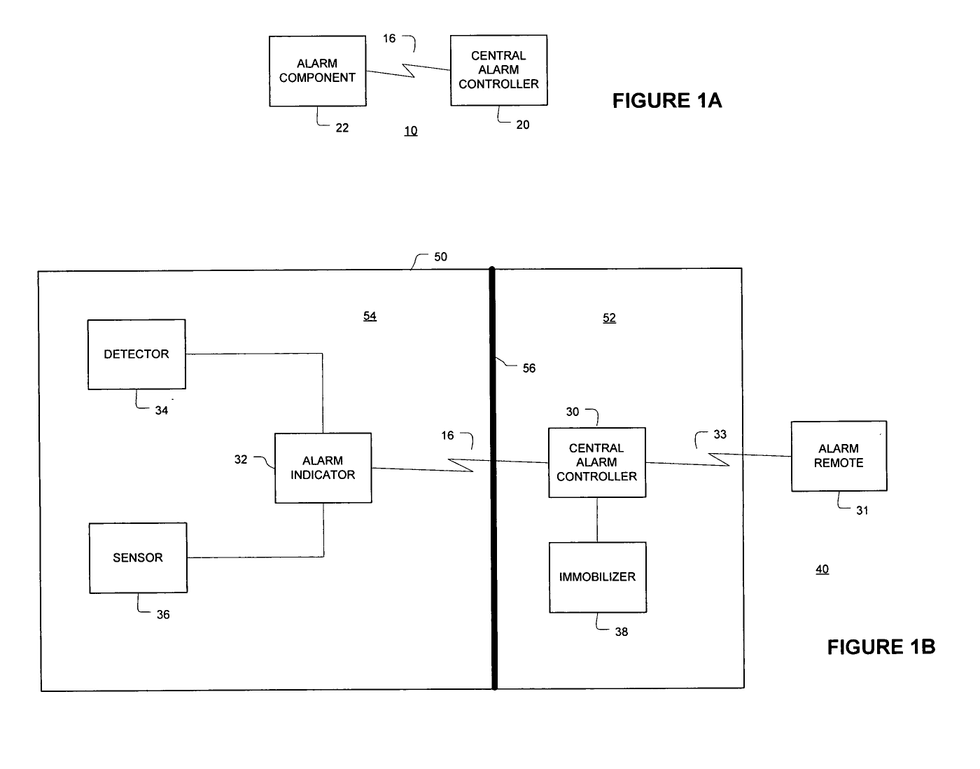

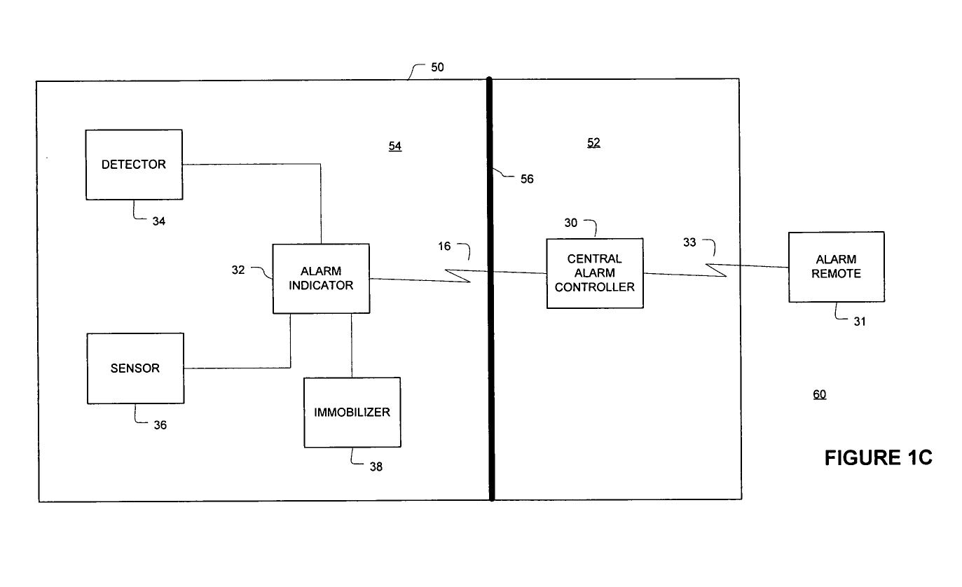

FIG. 1A is a simplified block diagram of an exemplary mobile alarm system 10 in accordance with the present invention. The mobile alarm system 10 includes a central alarm controller 20 and an alarm component 22 that are geographically separated. The controller 20 and component 22 communicate wirelessly via a link 16. FIG. 1B is a block diagram of an exemplary mobile alarm system 40 in accordance with the present invention fixably implemented in a vehicle 50. The vehicle 50 includes a passenger compartment 52 and engine compartment 54 that are separated by an engine wall 56. The mobile alarm system 40 includes a central alarm controller 30, alarm indicator 32, detector 34, sensor 36, immobilizer 38, and alarm remote 31. The central alarm controller 30 usually fixably located in the vehicle 50. In addition, the alarm indicator or component 32 is also fixably located in the vehicle 50 in an exemplary embodiment. In this system 40, the alarm indicator 32 is separated from the central alarm controller 30 by the vehicle fire wall 56. In this exemplary alarm system, the central alarm controller 30 communicates with the alarm indicator wirelessly via the link 16. This configuration does not require one or more wires to be passed through the vehicle engine/fire wall 56 to enable communication between the alarm indicator 32 and central alarm controller 30.

In the exemplary embodiment alarm system 40, the alarm indicator 32 is coupled to a detector 34 and a sensor 36. The indicator 32 may be coupled to the detector 34 and sensor 36 by one or more wires or wirelessly. The detector 34 may detect the condition of one or more alarm triggering devices, such as a hood pin, motion detector, or other device. The sensor 36 may sense one or more measurable physical conditions of object(s) located in the engine compartment 54, such as the engine temperature, engine revolutions per minute (“RPM”), or other measurable physical conditions. The alarm indicator 32 may receive data generated by the sensor 36 and detector 34, format the data, and forward the data to the central alarm controller 30 via the wireless link 16. The alarm indicator 32 may receive alarm state information from the central alarm controller 30 and generate an alarm indication, such as powering one or more sirens, when an alarm condition is detected or indicated by the central alarm controller 30. Further, in one embodiment the alarm indicator 32 may generate an alarm indication when communication between itself and the central alarm controller 30 has not occurred within a predetermined time period. The alarm indicator 32 may also generate an alarm condition based on a locally detected alarm event, i.e., independent of the central alarm controller 30.

In the exemplary alarm system 40, the central alarm controller 30 also communicates with an immobilizer 38 and an alarm remote 31. When an alarm state is detected/tripped, the central alarm controller 30 may direct the immobilizer 38 to restrict engine activation where immobilizers 38 are known to those of skill of the art of mobile alarm systems. The alarm controller 30 may communicate via one or more wires or wirelessly with the immobilizer 38. The alarm remote 31 may arm and disarm the alarm system 40 via a wireless communication link 33 with the central alarm controller 30. The alarm remote 31 may also receive alarm and engine state information via the wireless communication link 33 from the central alarm controller 30. The alarm remote 31 may display this information in a format discernable by a user. The mobile alarm system 40 may employ any wireless communication protocol for the wireless links 16 and 33. The wireless communication protocol for the links 16 and 33 may the same or different. In one embodiment, the wireless link 33 may be a highly secure link and the wireless link 16 may be a moderately secure link based on the employed communication protocols.

FIG. 1C is a block diagram of another exemplary mobile alarm system 60 in accordance with the present invention implemented in a vehicle 50. In this alarm system 60 the immobilizer 38 is located in the engine compartment and coupled to the alarm indicator 32. Placement of the immobilizer 38 within the engine compartment 54 may reduce tampering or bypassing the immobilizer 38. In this system 60, the immobilizer 38 may be activated based on a local event (detected by detector 34) or an alarm signal received from the central alarm controller 30.

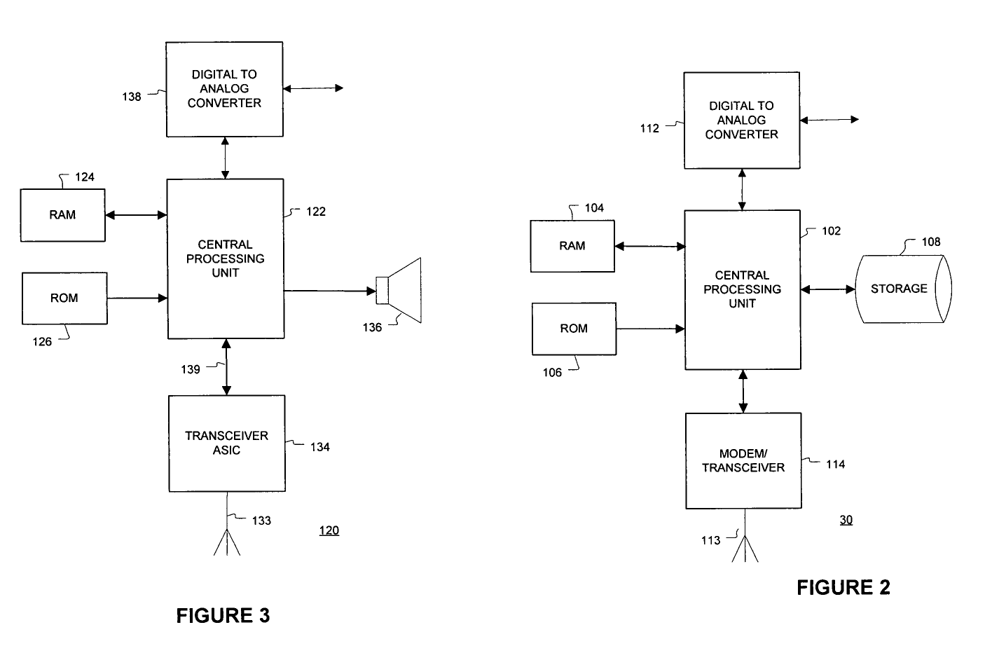

FIG. 2 is a block diagram of an exemplary central alarm controller 30 that may be included in an exemplary alarm system of the present invention. The exemplary central alarm controller 30 may include a central processing unit (“CPU”) 102, a random access memory (“RAM”) 104, a read only memory (“ROM”) 106, a storage unit 108, an antenna 113, a modem/transceiver 114, and a digital to analog converter (“DAC”) 114. The modem/transceiver 114 may wirelessly communicate, in a well-known manner, with an alarm indicator 32 or alarm remote 312 via the antenna 113. The CPU 102 directs communications with the modem 114 for messages between controller 30 and the indicator 32 and the alarm remote 31.

The ROM 106 may store program instructions to be executed by the CPU 102. The RAM 104 may be used to store temporary program information and data received from the alarm indicator and other detectors (not shown). The storage unit 108 may comprise any convenient form of data storage and may be used to store the data. The digital to analog converter 112 may be employed to transmit analog control signals to devices such as the immobilizer 38 and receive analog signals from other devices, such as detectors (not shown).

FIG. 3 is a block diagram of an exemplary alarm indicator or component 120 that may be included in an exemplary alarm system of the present invention. The exemplary device 120 may include a CPU 122, a RAM 124, a ROM 126, a transceiver application specific integrated circuit (ASIC) 134, an alarm state indicator 136, in particular, a speaker or a siren, a DAC 138, and an antenna 133. The ROM 126 is coupled to the CPU 122 and may store the program instructions executed by the CPU 122. The RAM 124 is coupled to the CPU 122 and may store temporary program data, sensor data, detector data, and central alarm controller 30 messages. The transceiver ASIC 134 may include an instruction set necessary to communicate data signals over the wireless link 16 (FIGS. 1A, 1B, or 1C). The ASIC 134 is coupled to the antenna 133 to communicate signals via the link 16. When a data signal is received by the transceiver ASIC 134, the data is transferred to the CPU 122 via a serial bus 139.

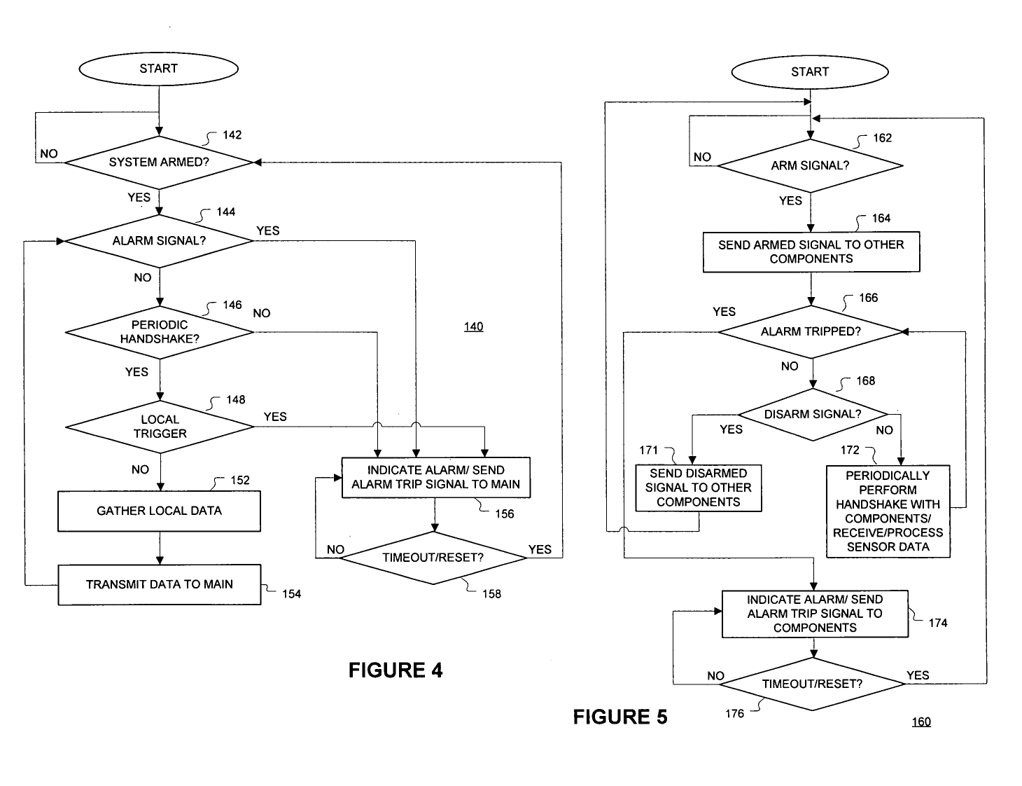

FIG. 4 depicts an exemplary process 140 that may be executed or performed by an exemplary alarm indicator or component 32 or 120 in accordance with the teachings of the present invention. In the exemplary process 140, the alarm indicator 32 remains inactive until a system armed signal is received from the central alarm controller 30 (step 142). In another embodiment, the alarm remote 31 may generate a system armed message. In this embodiment, the alarm indicator 32 remains inactive until a system armed signal is received from the central alarm controller 30 or the alarm remote 31 (step 142). The exemplary process 140 then determines whether the central alarm controller 30 has generated an alarm state signal (step 144), i.e., the alarm indicator 32 receives an alarm state or trigger/trip signal from the controller 30. When an alarm trigger/trip signal is detected, the process 140 generates an alarm indication (such as activating a siren) (step 156). The process 140 may continue to generate the alarm indication until a timeout has occurred or a system disarmed message is received (step 158). The central alarm controller 30 or alarm remote 31 may generate the system disarmed message in an exemplary embodiment.

In an exemplary embodiment, the process 140 may generate an alarm indication when no signal has been received from the central alarm controller 30 within a predetermined time interval via a periodic handshake procedure (step 146). In the exemplary process 140, one or more local triggers may also be monitored (step 148) (via the DAC 138 in the alarm indicator 120 shown in FIG. 3). When a local trigger is detected, the process 140 may send an alarm trigger event message to the central alarm controller 30 (step 156). The process 140 may also generate an alarm indication (step 156) independent of the central alarm controller 30 in an exemplary embodiment. When no alarm condition or trigger is detected while the system is armed, the process 140 may gather local data (from one or more sensors in one embodiment) (step 152) and transmit the data to the central alarm controller 30 (step 154).

FIG. 5 depicts an exemplary process 160 that may be executed or performed by an exemplary central alarm controller 30 in accordance with the teachings of the present invention. In the exemplary process 160 the corresponding alarm system is initially disarmed. The process 160 waits for an arming signal at step 162. An alarm remote 31 may generate an arming signal in one embodiment. When an arming signal is received, the process 160 may send a system armed signal to alarm components at step 164. In an exemplary embodiment, the process 160 may send the system armed signal via wire or wireless techniques. In the embodiments shown in FIGS. 1A, 1B, or 1C, the process 160 may send a system armed signal via the wireless link 16 to the alarm indicator or component 16 or 32.

The process 160 then determines whether an alarm trigger has been tripped at step 166. The alarm trigger may be received from an alarm component via a wire or wireless communication link, e.g., the alarm indicator 32 may wirelessly send an alarm trip signal. When the alarm is tripped, the process 160 may generate an alarm indication and send an alarm trip signal to other alarm components at step 174. In the exemplary embodiment the alarm trip signal may be send to other alarm components via a wire or wireless communication link. The process 160 may remain in an alarm state until a time out period has expired or an alarm reset or disarm signal is received at step 176. The process 160 then returns to step 162, awaiting receipt of an alarm arming signal.

At step 166 when an alarm has not been tripped the process 160 determines whether an alarm disarm signal has been received at step 168. When an alarm disarm signal has been received, the process 160 may send an alarm disarmed signal to other alarm components (via a wireless or wired communication link) at step 171. At step 168 when an alarm disarm signal has not been received, the process 160 may periodically communicate with alarm components (perform a predetermined handshake process) at step 172. The process 160 may also receive data from alarm components, process the data, and send the data to other alarm components at step 172. For example, the process 160 may receive engine data in a data signal from an alarm component and send the engine data to another alarm component, such as an alarm remote.

While this invention has been described in terms of a best mode for achieving the objectives of the invention, it will be appreciated by those skilled in the wireless communications art that variations may be accomplished in view of these teachings without deviating from the spirit or scope of the present invention. For example, the present invention may be implemented using any combination of computer programming software, firmware or hardware. As a preparatory step to practicing the invention or constructing an apparatus according to the invention, the computer programming code (whether software or firmware) according to the invention will typically be stored in one or more machine readable storage mediums such as fixed (hard) drives, diskettes, optical disks, magnetic tape, semiconductor memories such as ROMs, PROMs, etc., thereby making an article of manufacture in accordance with the invention. The article of manufacture containing the computer programming code is used by either executing the code directly from the storage device, by copying the code from the storage device into another storage device such as a hard disk, RAM, etc., or by transmitting the code on a network for remote execution.

1. A mobile alarm system component fixably located within a passenger vehicle, the component comprising:
means for wirelessly receiving signals from a mobile alarm controller; and
means for performing an alarm indication function based on signals received from the mobile alarm controller.

2. The mobile alarm system component of claim 2, wherein the means for performing an alarm indication function includes means for performing an alarm indication function when a signal has not been received from the mobile alarm controller for a predetermined time interval.

3. The mobile alarm system component of claim 2, wherein the means for performing an alarm indication function includes means for generating an audible alarm indication based on signals received from the mobile alarm controller.

4. The mobile alarm system component of claim 2, wherein the mobile alarm controller is fixably located within the passenger vehicle.

5. The mobile alarm system component of claim 2, the passenger vehicle having a first and a second compartment where the compartments are physically separated and wherein the means for wirelessly receiving signals from a mobile alarm controller is fixably located within the first compartment of the passenger vehicle and the mobile alarm controller is fixably located in the second compartment.

6. The mobile alarm system component of claim 5, wherein the first compartment is an engine compartment.

7. The mobile alarm system component of claim 6, wherein the second compartment is a passenger compartment.

8. A mobile alarm system fixably located within a passenger vehicle, the system comprising:
a mobile alarm controller operable to enable wireless data communications; and
a mobile alarm component operable to enable wireless data communications with the mobile alarm controller, the component including a processor operable to perform an alarm indication function based upon signals received from the mobile alarm controller.

9. The mobile alarm system of claim 8, wherein the component processor is operable to perform an alarm indication function when a signal has not been received from the mobile alarm controller for a predetermined time interval.

10. The mobile alarm system of claim 8, wherein the component processor is operable to cause the generation of an audible alarm indication based on signals received from the mobile alarm controller.

11. The mobile alarm system of claim 8, the passenger vehicle having a first and a second compartment where the compartments are physically separated and wherein the mobile alarm component is fixably located within the first compartment of the passenger vehicle and the mobile alarm controller is fixably located in the second compartment.

12. The mobile alarm system of claim 11, wherein the first compartment is an engine compartment.

13. The mobile alarm system component of claim 12, wherein the second compartment is a passenger compartment.

14. A mobile alarm system component method, the mobile alarm system component fixably located within a passenger vehicle, the method comprising the steps of:
a) wirelessly receiving signals from a mobile alarm controller; and
b) performing an alarm indication function based on signals received from the mobile alarm controller.

15. The mobile alarm system component method of claim 14, wherein step b) includes performing an alarm indication function when a signal has not been received from the mobile alarm controller for a predetermined time interval.

16. The mobile alarm system component method of claim 14, wherein step b) includes generating an audible alarm indication based on signals received from the mobile alarm controller.

17. The mobile alarm system component method of claim 14, wherein the mobile alarm controller is fixably located within the passenger vehicle.

18. The mobile alarm system component method of claim 14, the passenger vehicle having a first and a second compartment where the compartments are physically separated and wherein the mobile alarm component is fixably located within the first compartment of the passenger vehicle and the mobile alarm controller is fixably located in the second compartment.

19. The mobile alarm system component method of claim 18, wherein the first compartment is an engine compartment.

20. The mobile alarm system component method of claim 19, wherein the second compartment is a passenger compartment.

21. A method of installing a mobile alarm system within a passenger vehicle, the method comprising the steps of:
a) fixably installing in the passenger vehicle a mobile alarm controller operable to enable wireless data communications in the passenger vehicle; and
b) fixably installing in the passenger vehicle a mobile alarm component operable to enable wireless data communications with the mobile alarm controller, the component including a processor operable to perform an alarm indication function based upon signals received from the mobile alarm controller.

22. The method of claim 21, wherein the component processor is operable to perform an alarm indication function when a signal has not been received from the mobile alarm controller for a predetermined time interval.

23. The method of claim 22, wherein the component processor is operable to cause the generation of an audible alarm indication based on signals received from the mobile alarm controller.

24. The method of claim 22, the passenger vehicle having a first and a second compartment where the compartments are physically separated and wherein step a) includes fixably installing the mobile alarm component within the first compartment of the passenger vehicle and step b) includes fixably installing the mobile alarm controller in the second compartment.

25. The method of claim 24, wherein the first compartment is an engine compartment.

26. The method of claim 25, wherein the second compartment is a passenger compartment.
